(19) United States
(12) Patent Application Publication
(10) Pub. No.: US 2023/0073239 A1
(43) Pub. Date: Mar. 9, 2023

(54) STORAGE DEVICE AND METHOD OF OPERATING THE SAME

(71) Applicant: Samsung Electronics Co., Ltd., Suwon-si (KR)

(72) Inventors: Sungmin Jang, Hwaseong-si (KR); Kibeen Jung, Incheon (KR); Donghyub Kang, Seoul (KR); Byeonghui Kim, Hwaseong-si (KR); Hyunkyo Oh, Yongin-si (KR); Sanghyun Choi, Seoul (KR)

(21) Appl. No.: 17/812,461

(22) Filed: Jul. 14, 2022

(30) Foreign Application Priority Data
Sep. 7, 2021 (KR) 10-2021-0118826

(51) Int. Cl. G06F 3/06; G06N 20/00; G06F 12/02

(52) U.S. Cl. CPC G06F 3/0611; G06N 20/00; G06F 3/0655; G06F 3/0679; G06F 12/0253

(57) ABSTRACT

A method of operating a storage device includes receiving a learning request for setting a new parameter, evaluating a performance of a workload using a current parameter, performing machine learning in response to the learning request to infer relational expressions between a parameter and corresponding evaluation metrics, using performance evaluation information according to a performance evaluation of the workload and a plurality of learning models, deriving a new parameter using the inferred relational expressions, and applying the new parameter to a firmware algorithm.

### CROSS-REFERENCE TO RELATED APPLICATION(S)

This U.S. non-provisional patent application claims priority under 35 USC 119(a) to Korean Patent Application No. 10-2021-0118826 filed on Sep. 7, 2021 in the Korean Intellectual Property Office, the entire disclosure of which is incorporated by reference in its entirety herein.

### 1. TECHNICAL FIELD

The present inventive concept relates to a storage device and a method of operating the same.

### 2. DISCUSSION OF RELATED ART

Firmware is a specific class of computer software that may provide control of hardware that is specific to a device. Firmware, such as the basic input/output system (BIOS) of a personal computer (PC), may contain basic functions of devices, and may provide hardware abstraction services to high-level software such as an operating system (OS).

Recently, performance requirements of customers have been gradually increasing. Quality of service (QoS) is a measurement of the overall performance of a service. Companies are gradually demanding not only Read QoS, but also Write QoS. To respond to such requirements, the functions and complexity of firmware are increasing. Accordingly, the number of parameters related to firmware is also increasing. However, it is difficult to determine how to set these parameters to ensure optimal performance.

### SUMMARY

Example embodiments provide a storage device in which a performance parameter optimization process may be automated, storage device performance may be significantly increased, and developer effort and time consumed in parameter tuning may be reduced, and a method of operating the same.

According to an example embodiment, a method of operating a storage device includes receiving a learning request for learning a new parameter value for a parameter; evaluating a performance of a workload using a current parameter value of the parameter to generate performance metrics; performing machine learning using a plurality of learning models in response to the learning request to infer relational expressions between the parameter and the performance metrics, using performance evaluation information; deriving the new parameter value using the inferred relational expressions; and applying the new parameter value to a firmware algorithm.

According to an example embodiment, a storage device includes at least one non-volatile memory device; and a controller connected to control pins providing a command latch enable (CLE) signal, an address latch enable (ALE) signal, a chip enable (CE) signal, a write enable (WE) signal, a read enable (RE) signal, and a data strobe (DQS) signal to the at least one nonvolatile memory device, and controlling the at least one non-volatile memory device. The controller includes a buffer memory storing a plurality of learning models, and a processor driving a parameter optimizer in response to a learning request from an external device for learning a new parameter value for a parameter, and the parameter optimizer infers respective relational expressions between the parameter and respective performance metrics using the plurality of learning models, derives the new parameter value using the inferred relational expressions, and incorporates the new parameter value into a storage algorithm.

According to an example embodiment, a method of operating a storage device includes receiving a learning request for learning a new parameter value for a parameter; evaluating a workload performance for a current value of the parameter to generate performance metrics; storing the performance metrics; inferring relational expressions between the parameter and the workload performance using the performance metrics; deriving a new value of the parameter using the relational expressions; incorporating the new value of the parameter into a firmware algorithm; and when a number of iterations is not greater than a predetermined value, increasing the number of iterations by 1 and re-performing the evaluating of the workload performance.

### BRIEF DESCRIPTION OF DRAWINGS

The above and other aspects and features of the present inventive concept will be more clearly understood from the following detailed description, taken in conjunction with the accompanying drawings, in which:

FIG. 1 is a diagram illustrating, by way of example, a storage device 10 according to an example embodiment;

FIG. 2 is a diagram illustrating by way of example a nonvolatile memory device 100 illustrated in FIG. 1;

FIG. 3 is a diagram illustrating by way of example a controller 200 according to an example embodiment;

FIGS. 4A and 4B are diagrams conceptually illustrating a parameter optimizer 211 of a storage device 10 according to an example embodiment;

FIG. 5 is a diagram illustrating an example of a parameter according to an example embodiment;

FIG. 6 is a diagram illustrating, by way of example, a process of performing a parameter optimization process in the parameter optimizer 211 of the storage device 10 according to an example embodiment;

FIG. 7 is a diagram illustrating, by way of example, evaluation history information stored in an evaluation history storage unit 211-3 illustrated in FIG. 6;

FIG. 8 is a diagram conceptually illustrating an operation of deriving an optimal parameter of a storage device according to an example embodiment;

FIG. 9 is a flowchart illustrating by way of example a method of operating a storage device according to an example embodiment;

FIG. 10A is a diagram illustrating a process of deriving an optimal parameter of a storage device using a machine learning model according to an example embodiment, and FIG. 10B is a diagram illustrating a result according to the above-described optimal parameter deriving process;

FIG. 11 is a ladder diagram illustrating a process of optimizing a real-time parameter of a storage device according to an example embodiment;

FIG. 12 is a diagram illustrating by way of example a storage device 20 according to an embodiment; and

FIG. 13 is a diagram illustrating by way of example a data center to which a memory device according to an example embodiment is applied.

### DETAILED DESCRIPTION

Hereinafter, example embodiments of the present inventive concept will be described clearly and in detail to the extent that a person skilled in the art may implement the present inventive concept using the drawings.

In a storage device and a method of operating the same according to an example embodiment, the performance of the storage device may be significantly increased by automating a performance parameter optimization process based on a Bayesian optimization scheme, and a developer's effort and time consumed when tuning firmware parameters may be significantly reduced. In the storage device and the method of operating the same according to an example embodiment, relational expressions between firmware parameters and respective evaluation metrics may be respectively inferred using a plurality of models, and optimal parameters may be derived by comprehensively considering the inferred relational expressions.

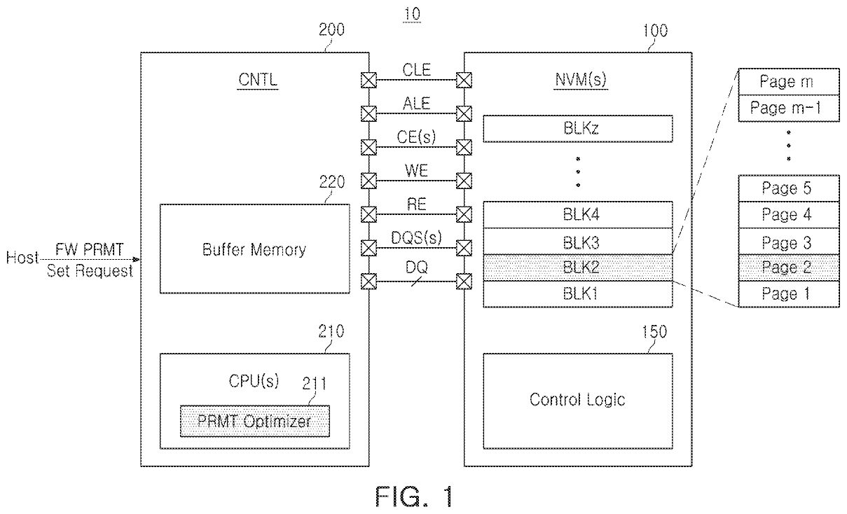

FIG. 1 is a diagram illustrating, by way of example, a storage device 10 according to an example embodiment. Referring to FIG. 1, the storage device 10 may include at least one nonvolatile memory device (NVM(s)) 100, and a controller (CNTL) 200 (e.g., a control circuit).

At least one non-volatile memory device 100 may be implemented to store data. The nonvolatile memory device 100 may be a NAND flash memory, a vertical NAND flash memory, a NOR flash memory, a resistive random access memory (RRAM), a phase-change memory (PRAM), a magnetoresistive random access memory (MRAM), a ferroelectric random access memory (FRAM), a spin transfer torque random access memory (STT-RAM), or the like. Also, the nonvolatile memory device 100 may be implemented as a three-dimensional array structure. The present inventive concept is applicable not only to a flash memory device in which the charge storage layer is constituted by a conductive floating gate, but also to a charge trap flash (CTF) in which the charge storage layer is constituted by an insulating layer. Hereinafter, for convenience of description, the nonvolatile memory device 100 will be referred to as a vertical NAND flash memory device (VNAND).

In addition, the nonvolatile memory device 100 may be implemented to include a plurality of memory blocks BLK1 to BLKz (where z is an integer greater than or equal to 2), and control logic 150 (e.g., a logic circuit). Each of the plurality of memory blocks BLK1 to BLKz may include a plurality of pages Page 1 to Page m, where m is an integer greater than or equal to 2. Each of the plurality of pages Page 1 to Page m may include a plurality of memory cells. Each of the plurality of memory cells may store at least one bit.

The control logic 150 may be implemented to receive a command and an address from the controller (CNTL) 200 and to perform an operation (a program operation, a read operation, an erase operation, or the like) corresponding to the received command, on memory cells corresponding to the address. The controller (CNTL) 200 may be connected to at least one nonvolatile memory device 100 through a plurality of control pins transmitting control signals (e.g., CLE, ALE, CE(s), WE, RE, and the like). Also, the controller (CNTL) 200 may be implemented to control the nonvolatile memory device 100 using the control signals CLE, ALE, CE(s), WE, RE, and the like. For example, the nonvolatile memory device 100 latches a command or an address at an edge of a write enable (WE)/read enable (RE) signal according to a command latch enable (CLE) signal and an address latch enable (ALE) signal, thereby performing a program operation/read operation/erase operation. For example, during a read operation, the chip enable signal CE is activated, CLE is activated in a command transmission period, ALE is activated in an address transmission period, and RE may be toggled in a period in which data is transmitted through a data signal line DQ. A data strobe signal DQS may be toggled with a frequency corresponding to the data input/output speed. The read data may be sequentially transmitted in synchronization with the data strobe signal DQS.

In addition, the controller 200 may include at least one processor (Central Processing Unit (CPU(s)) 210, and a buffer memory 220.

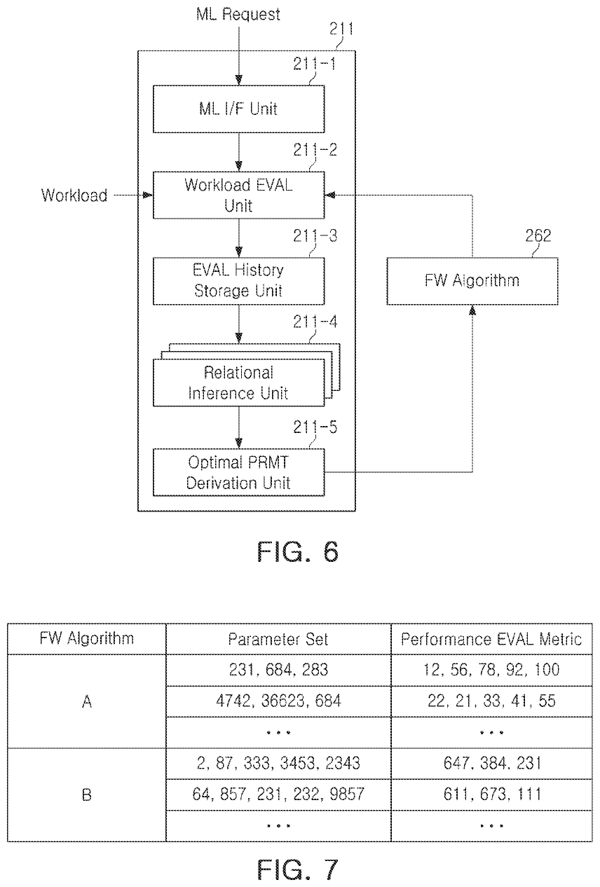

The processor 210 may be implemented to control the overall operation of the storage device 10. The processor 210 may perform various management operations, such as cache/buffer management, firmware management, garbage collection management, wear leveling management, data redundancy removal management, read refresh/reclaim management, bad block management, multi-stream management, mapping management of host data and non-volatile memory, Quality of Service (QoS) management, system resource allocation management, non-volatile memory queue management, read level management, erase/program management, hot/cold data management, power loss protection management, dynamic thermal management, initialization management, Redundant Array of Inexpensive Disk (RAID) management, and the like. The processor 210 may perform the various management operations using a storage or firmware algorithm (e.g., see 262 in FIG. 6).

In addition, the processor 210 may be implemented to drive a parameter (PRMT) optimizer 211. The parameter optimizer 211 may derive an optimal parameter value of a firmware parameter of the algorithm in response to a firmware parameter setting request from an external device (e.g., a host), and update the firmware parameter with the derived optimal parameter value of the firmware parameter. For example, the parameter optimizer 211 may infer performance relations related to firmware parameters by performing machine learning using a plurality of learning models, and may derive an optimal firmware parameter using the inferred performance relations.

The buffer memory 220 may be implemented as a volatile memory (e.g., a static random access memory (SRAM), dynamic RAM (DRAM), synchronous RAM (SDRAM), or the like), or a non-volatile memory (a flash memory, phase-change RAM (PRAM), Magneto-resistive RAM (MRAM), resistive RAM (ReRAM), ferro-electric RAM (FRAM), or the like). In an example embodiment, the buffer memory 220 may store a plurality of learning models required to drive the parameter optimizer 211. The learning models may be machine learning models.

A general storage device determines parameter values when firmware is issued, and does not change these parameter values thereafter. However, parameter values determined at the time of firmware issuance are only values optimized for a benchmark workload, and are not workload optimized for a user's workload. Therefore, a general storage device will not have an optimal performance according to a user's workload.

The storage device 10 according to an example embodiment of the present inventive concept may optimize at least one parameter according to a user's workload by driving the parameter optimizer 211 in response to an external firmware parameter setting request. Accordingly, the storage device 10 according to an example embodiment of the present inventive concept may increase the performance according to the optimization of the firmware parameters.

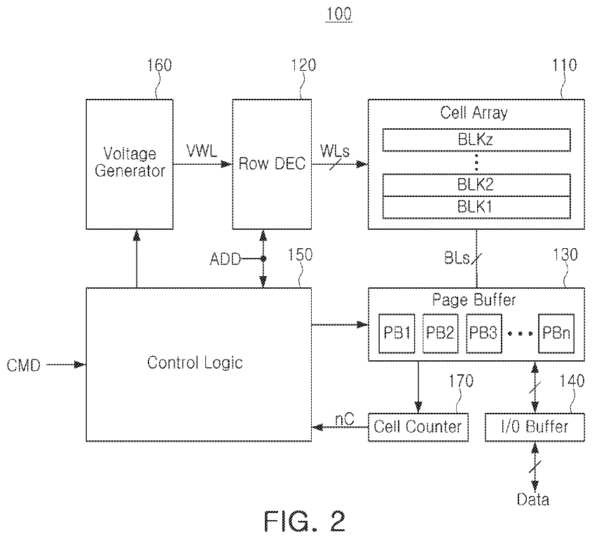

FIG. 2 is a diagram illustrating, by way of example, the nonvolatile memory device 100 illustrated in FIG. 1. Referring to FIG. 2, the nonvolatile memory device 100 may include a memory cell array 110, a row decoder 120 (e.g., a decoder circuit), a page buffer circuit 130, an input/output buffer circuit 140, a control logic 150, a voltage generator 160, and a cell counter 170 (e.g., a counter circuit).

The memory cell array 110 may be connected to the row decoder 120 through word lines WLs or selection lines SSL and GSL. The memory cell array 110 may be connected to the page buffer circuit 130 through bit lines BLs. The memory cell array 110 may include a plurality of cell strings. Each channel of the cell strings may be formed in a vertical or horizontal direction. Each of the cell strings may include a plurality of memory cells. In this case, the plurality of memory cells may be programmed, erased, or read by a voltage applied to the bit line BLs or the word line WLs. In general, a program operation is performed in units of pages, and an erase operation is performed in units of blocks. U.S. Pat. Nos. 7,679,133, 8,553,466, 8,654,587, 8,559,235, and 9,536,970, the disclosures of which are incorporated by reference in their entirety, disclose suitable configurations for the memory cells. In an example embodiment, the memory cell array 110 may include a two-dimensional memory cell array, and the two-dimensional memory cell array may include a plurality of NAND strings disposed in a row direction and a column direction.

The row decoder 120 may be implemented to select any one of the memory blocks BLK1 to BLKz of the memory cell array 110 in response to the address ADD. The row decoder 120 may select any one of the word lines of the memory block selected in response to the address ADD. The row decoder 120 may transfer a word line voltage VWL corresponding to an operation mode to the word line of the selected memory block. During a program operation, the row decoder 120 may apply a program voltage and a verify voltage to a selected word line, and may apply a pass voltage to an unselected word line. During a read operation, the row decoder 120 may apply a read voltage to a selected word line and may apply a read pass voltage to an unselected word line.

The page buffer circuit 130 may be implemented to operate as a write driver or a sense amplifier. During a program operation, the page buffer circuit 130 may apply a bit line voltage corresponding to data to be programmed to the bit lines of the memory cell array 110. During a read operation or a verify read operation, the page buffer circuit 130 may sense data stored in the selected memory cell through the bit line BL. Each of the plurality of page buffers PB1 to PBn (n is an integer greater than or equal to 2) included in the page buffer circuit 130 may be connected to at least one bit line.

The input/output buffer circuit 140 provides externally-provided data to the page buffer circuit 130. The input/output buffer circuit 140 may provide the externally provided command CMD to the control logic 150. The input/output buffer circuit 140 may provide the externally provided address ADD to the control logic 150 or the row decoder 120. Also, the input/output buffer circuit 140 may output data sensed and latched by the page buffer circuit 130 externally.

The control logic 150 may be implemented to control the row decoder 120 and the page buffer circuit 130 in response to a command CMD transmitted from an external source (the controller 200, see FIG. 1).

The voltage generator 160 may be implemented to generate various types of word line voltages to be applied to the respective word lines under the control of the control logic 150, and a well voltage to be supplied to a bulk (e.g., a well region) in which memory cells are formed. The word line voltages applied to respective word lines may include a program voltage, a pass voltage, a read voltage, read pass voltages, and the like.

The cell counter 170 may be implemented to count memory cells corresponding to a specific threshold voltage range from data sensed by the page buffer circuit 130. For example, the cell counter 170 may count the number of memory cells having a threshold voltage in a specific threshold voltage range by processing data sensed in each of the plurality of page buffers PB1 to PBn.

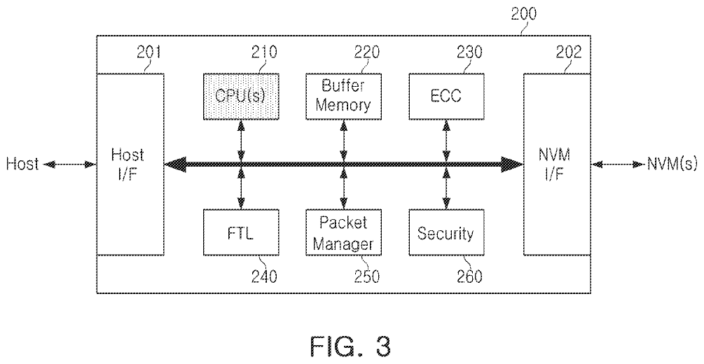

FIG. 3 is a diagram illustrating, by way of example, the controller 200 according to an example embodiment. Referring to FIG. 3, the controller 200 may include a host interface 201 (e.g., an interface circuit), a memory interface 202 (e.g., an interface circuit), at least one CPU 210, a buffer memory 220, an error correction circuit 230, a flash translation layer manager 240, a packet manager 250 (e.g., a logic circuit), and a security module 260 (e.g., a logic circuit).

The host interface 201 may be implemented to transmit and receive packets to and from the host. A packet transmitted from the host to the host interface 201 may include a command or data to be written to the nonvolatile memory device 100. A packet transmitted from the host interface 201 to the host may include a response to a command or data read from the nonvolatile memory device 100. In an example embodiment, the host interface 201 may be compatible with one or more of a Peripheral Component Interconnect express (PCIe) interface standard, a Universal Serial Bus (USB) interface standard, a Compact Flash (CF) interface standard, a Multimedia Card (MMC) interface standard, an embedded MMC (eMMC) interface standard, a thunderbolt interface standard, a Universal Flash Storage (UFS) interface standard, a Secure Digital (SD) interface standard, a memory stick interface standard, an extreme digital (xD)-picture card interface standard, an Integrated Drive Electronics (IDE) interface, a Serial Advanced Technology Attachment (SATA) interface standard, a Small Computer System Interface (SCSI) interface standard, a Serial Attached SCSI (SAS) interface standard, and an Enhanced Small Disk Interface (ESD).

The memory interface 202 may transmit data to be written to the nonvolatile memory device 100, to the nonvolatile memory device 100, or may receive data read from the nonvolatile memory device 100. The memory interface 202 may be implemented to comply with standard protocols such as Joint Electron Device Engineering Council (JEDEC) Toggle or Open NAND Flash Interface (ONFI).

The buffer memory 220 may temporarily store data to be stored in the nonvolatile memory device 100 or data read from the nonvolatile memory device 100. In an example embodiment, the buffer memory 220 may be a component provided in the controller 200. In another embodiment, the buffer memory 220 may be disposed outside of the controller 200.

The ECC circuit 230 may be implemented to generate an error correction code during a program operation and recover data using the error correction code during a read operation. For example, the ECC circuit 230 may generate an error correction code (ECC) for correcting a fail bit or an error bit of data received from the nonvolatile memory device 100. The ECC circuit 230 may generate data DATA to which a parity bit is added, by performing error correction encoding of data provided to the nonvolatile memory device 100. The parity bit may be stored in the nonvolatile memory device 100. Also, the ECC circuit 230 may perform error correction decoding on the data DATA output from the nonvolatile memory device 100. The ECC circuit 230 may correct an error using the parity bit. The ECC circuit 230 may correct an error using coded modulation such as Low Density Parity Check (LDPC) code, Bose-Chaudhuri-Hocquenghem (BCH) code, Turbo code, Reed-Solomon code, convolution code, Recursive Systematic Code (RSC), Trellis-Coded Modulation (TCM), or block coded modulation (BCM). On the other hand, when error correction is impossible in the error correction circuit 230, a read retry operation may be performed.

The flash translation layer manager 240 may perform various functions such as address mapping, wear-leveling, and garbage collection. The address mapping operation is an operation of changing a logical address received from the host into a physical address used to actually store data in the nonvolatile memory device 100. The wear-leveling is a technique for preventing excessive degradation of a specific block by ensuring that blocks in the nonvolatile memory device 100 are used uniformly, and for example, may be implemented by a firmware technique for balancing erase counts of physical blocks. The garbage collection is a technique for securing usable capacity in the nonvolatile memory device 100 by a method of copying valid data of a block to a new block and then erasing an existing block.

The packet manager 250 may generate a packet according to a protocol of an interface negotiated with the host or parse various information from a packet received from the host.

The security module 260 may perform at least one of an encryption operation and a decryption operation on data input to the CPU 210, using a symmetric-key algorithm. The security module 260 may include an encryption module and a decryption module. In an example embodiment, the security module 260 may be implemented in hardware, software, or firmware or in various combinations of the same.

The security module 260 may be implemented to perform a security function of the storage device 10. For example, the security module 260 may perform a Self Encryption Disk (SED) function or a Trusted Computing Group (TCG) security function. The SED function may store encrypted data in the non-volatile memory device 100 using an encryption algorithm or may decrypt the encrypted data from the non-volatile memory device 100. This encryption/decryption operation may be performed using an internally generated encryption key. In an example embodiment, the encryption algorithm may be an Advanced Encryption Standard (AES) encryption algorithm, but is not limited thereto. The TCG security function may provide a mechanism to control access of the storage device 10 by a user. For example, the TCG security function may perform an authentication procedure between the external device and the storage device 10. In an example embodiment, the SED function or the TCG security function is optionally selectable. In addition, the security module 260 may be implemented to perform an authentication operation with an external device or to perform a fully homogeneous encryption function.

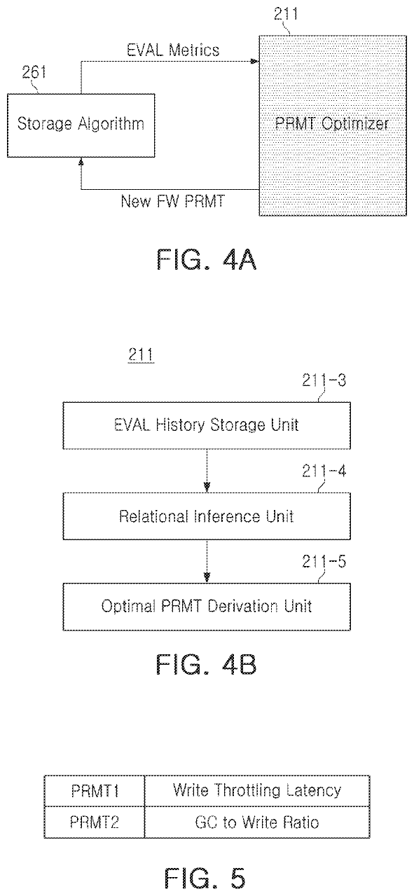

FIGS. 4A and 4B are diagrams conceptually illustrating the parameter optimizer 211 of the storage device 10 according to an example embodiment.

Referring to FIG. 4A, the parameter optimizer 211 may receive the performance metrics output from a storage algorithm 261 and derive an optimal firmware parameter using the performance metrics.

Referring to FIG. 4B, the parameter optimizer 211 may include an evaluation history storage unit 211-3, a relational inference unit 211-4, and an optimal parameter derivation unit 211-5.

The evaluation history storage unit 211-3 may store the performance metrics output from the storage algorithm 261. The relational inference unit 211-4 may infer at least one relational expression from the performance metrics stored in the evaluation history storage unit 211-3. The optimal parameter derivation unit 211-5 may derive an optimal parameter from the inferred relational expression. In this case, the derived parameter may be updated in the storage algorithm 261 as a new parameter.

FIG. 5 is a diagram illustrating an example of a parameter according to an example embodiment. Referring to FIG. 5, the parameter may include a first parameter PRMT1 and a second parameter PRMT2.

The first parameter PRMT1 may be write throttling latency. In this case, the write throttling latency refers to the waiting time for a write request from the host.

The second parameter PRMT2 may be a garbage collection to write ratio (GC to Write Ratio). In this case, the garbage collection-to-write ratio indicates a ratio between a write operation and a garbage collection.

In FIG. 5, two parameters are illustrated as an example. However, it should be understood that the parameters of the present inventive concept are not limited thereto.

FIG. 6 is a diagram illustrating by way of example a process of performing a parameter optimization process in the parameter optimizer 211 of the storage device 10 according to an example embodiment.

A learning mode interface 211-1 may receive a learning request from the host device and start a parameter optimization process. In this case, parameter optimization does not always operate, but may only operate in the learning mode. This is because there is a possibility of performance degradation due to trial and error in the optimal parameter learning process.

When the parameter optimization process is performed, a workload performance evaluation unit 211-2 may perform workload performance evaluation with respect to the currently set parameters of the storage device 10.

Thereafter, an evaluation history storage unit 211-3 may store the parameters of the storage device 10 and the evaluation result thereof. The evaluation history storage unit 211-3 may store and manage a firmware algorithm 262 (or a storage algorithm), a parameter set, and evaluation metrics in the form of a table. This table information (evaluation history information) may be used as an input of the relational inference unit 211-4. In this case, the evaluation history information may be stored in a volatile or a non-volatile memory medium.

The relational inference unit 211-4 may infer the relational expression corresponding to the parameter by using the table information. In this case, as the learning time is increased and accumulation of data is increased, the performance of the relational inference unit 211-4 may be improved. The relational inference unit 211-4 may infer a relational expression between the parameter set for each storage algorithm and the collected evaluation metrics by using the stored table information of the evaluation history storage unit 211-3 as an input.

The optimal parameter derivation unit 211-5 may derive an optimal parameter from the inferred plurality of relational expressions. In this case, the optimal parameter may be derived from a plurality of relational expressions using a Bayesian optimization scheme. The derived parameters may be reflected in the firmware algorithm 262.

FIG. 7 is a diagram illustrating, by way of example, evaluation history information stored in the evaluation history storage unit 211-3 illustrated in FIG. 6. Referring to FIG. 7, evaluation history information is stored in the form of a table having firmware algorithms A and B, a parameter set thereof, and performance evaluation metrics.

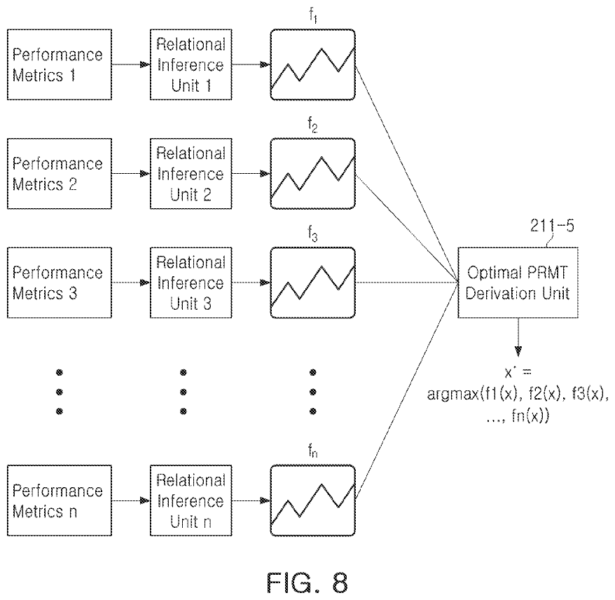

FIG. 8 is a diagram conceptually illustrating an operation of deriving an optimal parameter of a storage device according to an example embodiment.

When n evaluation metrics for the workload performed by the workload evaluation unit 211-2 are collected, n performance relational inference units may infer the relationship between the parameter x and the n performance metrics. In a case in which there are n performance metrics with respect to the parameter x, there will be as many performance relations as n performance metrics. Through learning (e.g., machine learning), unknown relational expressions may be inferred gradually by accumulating information while performing a workload.

When n relational expressions are derived by the relational inference unit 211-4, the optimal parameter derivation unit 211-5 may derive a new parameter x* overall having an optimal performance from the n relational expressions. The new parameter derived as above may be proposed as a new parameter set and applied to the firmware algorithm. The new parameter set may be a distinct set of parameters each set to a corresponding parameter value. Workload performance evaluation may proceed with respect to the new parameters applied thereafter. By repeating the above-described process a predetermined number of times, the optimal parameter derivation unit 211-5 may gradually find the optimal parameter values of the parameters of the set.

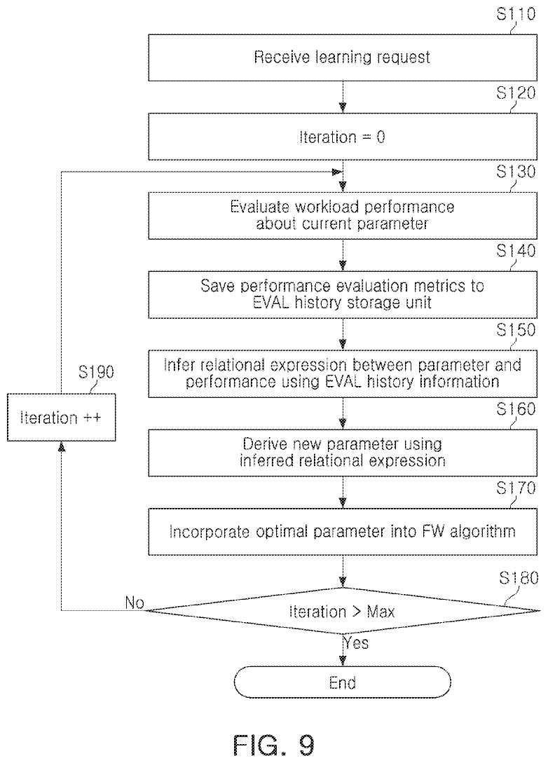

FIG. 9 is a flowchart illustrating, by way of example, a method of operating a storage device according to an example embodiment. Referring to FIGS. 1 to 9, the storage device 10 may operate as follows.

The parameter optimizer 211 of the storage device 10 receives a learning request for finding an optimal parameter from an external device (e.g., a host device) (S110). According to the learning request, the storage device 10 may enter a learning mode. The number of iterations of initial learning is set to be 0 (S120). The parameter optimizer 211 performs evaluation of workload performance on the current parameter to generate evaluation metrics (S130). The parameter optimizer 211 may evaluate performance of a workload when the current parameter is used. The parameter optimizer 211 stores the performance evaluation metrics in the evaluation history storage unit (S140). The parameter optimizer 211 infers at least one relational expression between the current parameter and the workload performance by using performance evaluation information (S150). The parameter optimizer 211 derives a new parameter using the inferred relational expressions (S160). The parameter optimizer 211 incorporates the derived parameter as the optimal parameter, into the firmware algorithm (S170). For example, the parameter optimizer 211 may incorporate the new parameter into the firmware algorithm.

Thereafter, the parameter optimizer 211 determines whether the number of learning iterations exceeds a maximum value Max (S180). For example, when the number of learning iterations is not greater than the maximum value Max, the number of learning iterations is increased by 1 (S190), and then the method resumes to operation S130. On the other hand, when the number of learning iterations is greater than the maximum value Max, the parameter learning operation will be terminated.

In an example embodiment, machine learning may be performed using each of a plurality of learning models to infer at least one of the relational expressions. In an example embodiment, at least one of the performance metrics may include a predetermined write latency (e.g., a predetermined percentile or percentage). In an example embodiment, performance metrics related to the parameter may be selected by a user. In an example embodiment, the evaluation metrics may include measures related to throughput, write quality (write QoS), read quality (read QoS), or reliability.

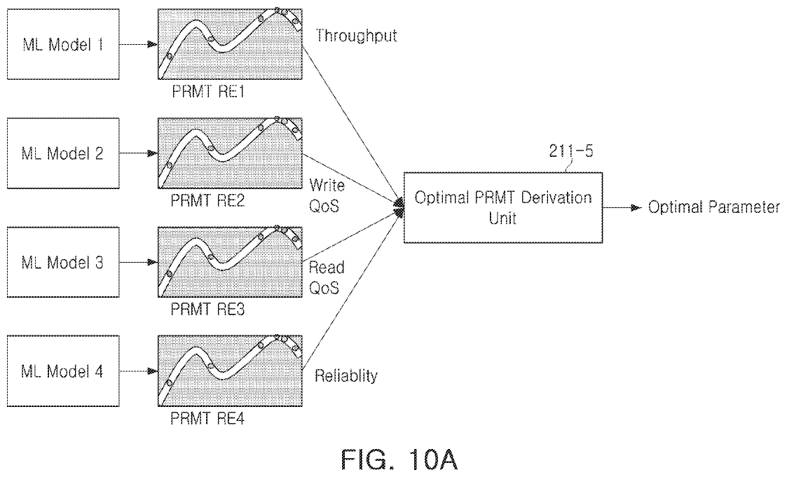

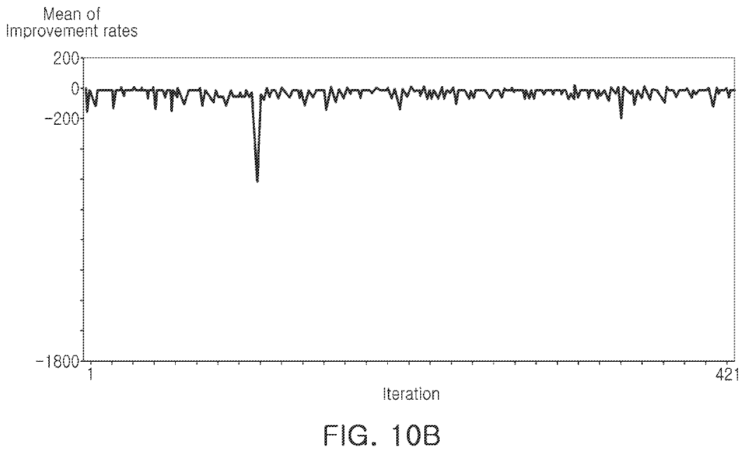

FIG. 10A is a diagram illustrating a process of deriving an optimal parameter of a storage device, using a machine learning model according to an example embodiment, and FIG. 10B is a diagram illustrating a result according to the above-described optimal parameter deriving process.

Referring to FIG. 10A, the storage device 10 according to an example embodiment respectively infers a relational expression between a parameter and each evaluation metric using learning models, and may derive an optimal parameter by comprehensively considering the relational expressions inferred by the optimal parameter derivation unit 211-5.

For example, a first learning model (ML Model 1) may be used to derive a first performance relational expression (PRMT RE1) related to a throughput-related performance metric. A second learning model (ML Model 2) may be used to derive a second performance relational expression (PRMT RE2) related to a write quality (Write QoS)-related performance metric. A third learning model (ML Model 3) may be used to derive a third performance relational expression (PRMT RE3) related to a read quality (Read QoS)-related performance metric. A fourth learning model (ML Model 4) may be used to derive a fourth performance relational expression (PRMT RE4) related to a reliability-related performance metric. The optimal parameter derivation unit 211-5 may derive an optimal parameter using the first to fourth performance relational expressions.

Although four learning models are illustrated in FIG. 10A, it should be understood that the number of learning models of the present inventive concept is not limited thereto.

As illustrated in FIG. 10B, as the number of learning iterations increases, the performance improvement rate gradually improves.

When evaluating the Write Command Quality of Service (QoS) improvement rate, the storage device according to an example embodiment of the present inventive concept may improve Write Latency 99% and 99.99% Percentile. In an example embodiment of the storage device, a module (Write-Flow-Control, Write-Throttling) closely related to write latency may be selected, and parameters in this module may be optimized. The evaluation workload is a combination of Host-Queue-Depth (1 to 256) and Read-Write-Mixed-Ratio (0% to 100%). In an embodiment, the Host-Queue-Depth is the number of commands that a Host can send or receive at a given time without suffering a performance degradation.

The write QoS compare table illustrates the improvement rate of optimized parameter latency compared to default parameter latency. The reduced ratio of optimized parameter latency compared to default parameter latency is illustrated. For example, as the numerical value decreases, the response time compared to the existing one decreases. Target latencies of 99% and 99.99% are equivalent or significantly improved. Average latency and throughput are equivalent. In detail, in write burst workload, an average of 10% or more is improved, and 99.9999% and max Latency are also significantly improved.

In an example embodiment, when the latency samples of the default parameter and the optimized parameter are sorted and compared in ascending order, the trade-off based on the 84% percentile is formed. In detail, the percentile latency of 84% or more is improving. Also, when increasing the percentile of 99% or more, all latencies are improving. Also, the optimized parameter latency has a low overall distribution, which indicates that the overall latency will be improved.

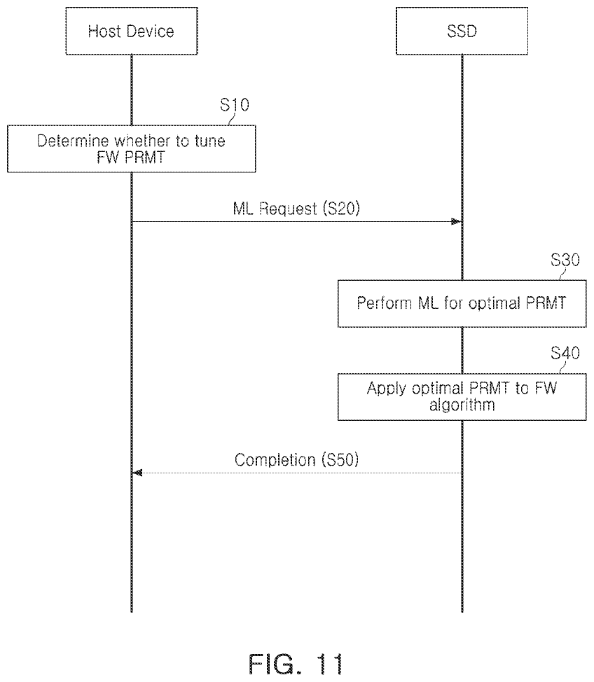

FIG. 11 is a ladder diagram illustrating a process of optimizing a real-time parameter of a storage device according to an example embodiment. Referring to FIGS. 1 to 11, a parameter optimization setting process of the storage device (SSD) according to an example embodiment of the present inventive concept may be performed as follows.

The host device determines whether tuning a firmware parameter of the storage device (SSD) is necessary (S10). The host device may determine whether to tune the firmware parameter using various conditions such as environment information (temperature information, input/output information, channel information, and the like), performance information and the like. In an example embodiment, the performance information may be transmitted from the storage device (SSD). U.S. Pat. No. 11,003,381 and U.S. Patent Publication 2021-0232336, the disclosures of which are incorporated by reference in their entirety, disclose details of outputting the performance information of the storage device (SSD).

When tuning of the firmware parameter is required, the host device transmits a learning request to the storage device (SSD) (S20). The storage device SSD may enter the learning mode in response to the learning request. Thereafter, the storage device SSD performs machine learning to find an optimal parameter based on a predetermined algorithm (S30). The storage device SSD applies the optimal parameter to the firmware algorithm (S40). Thereafter, the storage device SSD may output information corresponding to the completion of learning to the host device (S50).

On the other hand, the present inventive concept may be implemented by a processing unit for artificial intelligence that exclusively manages firmware parameter optimization.

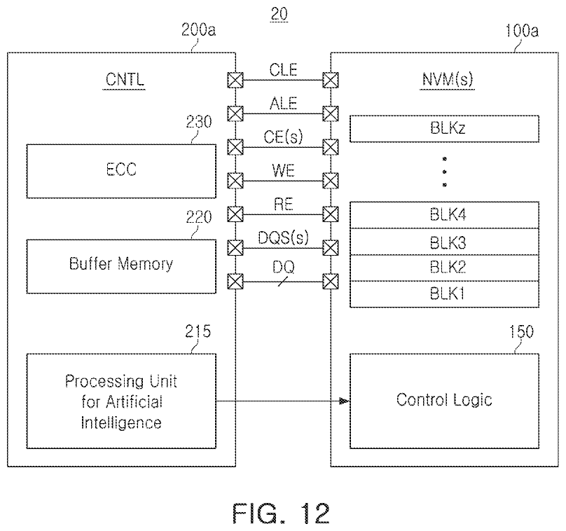

FIG. 12 is a diagram illustrating by way of example a storage device 20 according to an embodiment of the present inventive concept. Referring to FIG. 12, the storage device 20 may include a nonvolatile memory device 100a and a controller 200a.

The controller 200a may include a processing unit for artificial intelligence 215, for generation of an optimal parameter as compared to that illustrated in FIG. 1. The processing unit for artificial intelligence 215 may be implemented to derive an optimal parameter through the machine learning described in FIGS. 1 to 11 and to apply the derived parameter to a firmware algorithm.

The processing unit for artificial intelligence 215 may derive an optimal parameter through a machine learning method. The machine learning method may be performed based on at least one of various machine learning algorithms, such as a neural network, a Support Vector Machine (SVM), linear regression, a decision tree, Generalized Linear Models (GLM), random forests, Gradient Boosting Machine (GBM), deep learning, clustering, anomaly detection, dimension reduction, and the like. The machine learning method may receive at least one parameter, and use the received parameter to predict an error tendency for a corresponding memory block, based on a previously trained training model. In an example embodiment, the machine learning method may be performed by a hardware accelerator configured to perform learning. On the other hand, U.S. Pat. No. 10,802,728, U.S. Patent Publication 2020-0151539, U.S. Patent Publication 2021-050067, and U.S. Patent Publication 2021-0109669, the disclosures of which are incorporated by reference in their entirety, may disclose details of the machine learning method.

In an example embodiment, the processing unit for artificial intelligence 215 may tune a learning model used to find an optimal parameter, through machine learning. On the other hand, U.S. Patent Publication 2021-0072920, the disclosure of which is incorporated by reference in its entirety, may disclose details of tuning the learning model of the storage device through machine learning.

The present inventive concept may be applicable to a data server system.

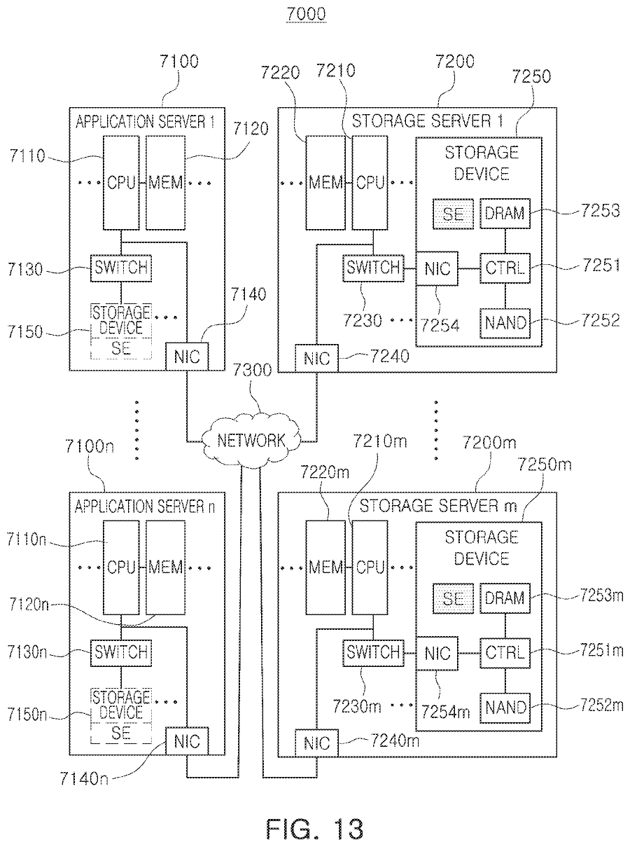

FIG. 13 is a diagram illustrating, by way of example, a data center to which a memory device according to an example embodiment is applied. Referring to FIG. 13, a data center 7000 is a facility that collects various types of data and provides services, and may also be referred to as a data storage center. The data center 7000 may be a system for operating a search engine and a database, and may be a computing system used in a business such as a bank or a government institution. The data center 7000 may include application servers 7100 to 7100n and storage servers 7200 to 7200m. The number of application servers 7100 to 7100n and the number of storage servers 7200 to 7200m may be variously selected according to an example embodiment, and the number of the application servers 7100 to 7100n and the number of the storage servers 7200 to 7200m may be different.

The application server 7100 or the storage server 7200 may include at least one of processors 7110 and 7210 and memories 7120 and 7220. In describing the storage server 7200 as an example, the processor 7210 may control the overall operation of the storage server 7200, access the memory 7220, and execute instructions and/or data loaded into the memory 7220. The memory 7220 may be a Double Data Rate Synchronous DRAM (DDR SDRAM), a High Bandwidth Memory (HBM), a Hybrid Memory Cube (HMC), a Dual In-line Memory Module (DIMM), an Optane DIMM, or a Non-Volatile DIMM (NVMDIMM). According to an example embodiment, the number of processors 7210 and the number of memories 7220 included in the storage server 7200 may be variously selected. In an example embodiment, the processor 7210 and the memory 7220 may provide a processor-memory pair. In an example embodiment, the number of processors 7210 and the number of memories 7220 may be different from each other. The processor 7210 may include a single-core processor or a multicore processor. The above description of the storage server 7200 may be similarly applied to the application server 7100. According to an example embodiment, the application server 7100 may not include a storage device 7150. The storage server 7200 may include at least one or more storage devices 7250. The number of storage devices 7250 included in the storage server 7200 may be variously selected according to an example embodiment.

The application servers 7100 to 7100n and the storage servers 7200 to 7200m may communicate with each other through a network 7300. The network 7300 may be implemented using Fiber Channel (FC), Ethernet or the like. In this case, FC is a medium used for relatively high-speed data transmission, and may use an optical switch providing high performance/high availability. Depending on the access method of the network 7300, the storage servers 7200 to 7200m may be provided as file storage, block storage, or object storage.

In an example embodiment, the network 7300 may be a storage-only network, such as a storage area network (SAN). For example, the SAN may be an FC-SAN that uses an FC network and is implemented according to FC Protocol (FCP). As another example, the SAN may be an IP-SAN that uses a TCP/IP network and is implemented according to an iSCSI (SCSI over TCP/IP or Internet SCSI) protocol. In other embodiments, the network 7300 may be a generic network, such as a TCP/IP network. For example, the network 7300 may be implemented according to protocols such as FC over Ethernet (FCoE), Network Attached Storage (NAS), and NVMe over Fabrics (NVMe-oF).

Hereinafter, the application server 7100 and the storage server 7200 will be mainly described. A description of the application server 7100 may be applied to other application servers 7100n, and a description of the storage server 7200 may also be applied to other storage servers 7200m.

The application server 7100 may store data requested to be stored by a user or a client in one of the storage servers 7200 to 7200m through the network 7300. Also, the application server 7100 may acquire data to be read-requested by a user or a client, from one of the storage servers 7200 to 7200m, through the network 7300. For example, the application server 7100 may be implemented as a web server or a Database Management System (DBMS).

The application server 7100 may access the memory 7120n or the storage device 7150n included in another application server 7100n through the network 7300, or may access memories 7220 to 7220m or storage devices 7250 to 7250m included in the storage servers 7200 to 7200m through the network 7300. Accordingly, the application server 7100 may perform various operations on data stored in the application servers 7100 to 7100n and/or the storage servers 7200 to 7200m. For example, the application server 7100 may execute a command to move or copy data between the application servers 7100 to 7100n and/or the storage servers 7200 to 7200m. At this time, data may be transferred to the memories 7120 to 7120n of the application servers 7100 to 7100n, from the storage devices 7250 to 7250m of the storage servers 7200 to 7200m through the memories 7220 to 7220m of the storage servers 7200 to 7200m, or may be directly transferred to the memories 7120 to 7120n of the application servers 7100 to 7100n. The data transferred through the network 7300 may be encrypted data for security or privacy.

Describing the storage server 7200 as an example, an interface 7254 may provide a physical connection between the processor 7210 and the controller 7251 and a physical connection between the NIC 7240 and the controller 7251. For example, the interface 7254 may be implemented in a Direct Attached Storage (DAS) method for directly connecting the storage device 7250 with a dedicated cable. Also, for example, the interface 7254 may be implemented in various interface methods, such as an Advanced Technology Attachment (ATA), Serial ATA (SATA), external SATA (e-SATA), Small Computer Small Interface (SCSI), Serial Attached SCSI (SAS), Peripheral Component Interconnection (PCI), PCI express (PCIe), NVM express (NVMe), IEEE 1394, universal serial bus (USB), secure digital (SD) card, multi-media card (MMC), embedded multi-media card (eMMC), a universal flash storage (UFS), an embedded universal flash storage (eUFS), a compact flash (CF) card interface, and the like.

The storage server 7200 may further include a switch 7230 and a NIC 7240. The switch 7230 may selectively connect the processor 7210 and the storage device 7250 or the NIC 7240 and the storage device 7250, under the control of the processor 7210.

In an example embodiment, the NIC 7240 may include a network interface card, a network adapter, and the like. The NIC 7240 may be connected to the network 7300 by a wired interface, a wireless interface, a Bluetooth interface, an optical interface, or the like. The NIC 7240 may include an internal memory, a DSP, a host bus interface, and the like, and may be connected to the processor 7210 and/or the switch 7230 through the host bus interface. The host bus interface may be implemented as one of the examples of the interface 7254 described above. In an example embodiment, the NIC 7240 may be integrated with at least one of the processor 7210, the switch 7230, and the storage device 7250.

In the storage servers 7200 to 7200m or the application servers 7100 to 7100n, the processor may send a command to the storage devices 7130 to 7130n and 7250 to 7250m or the memories 7120 to 7120n and 7220 to 7220m to program or read data. In this case, the data may be error-corrected data through an Error Correction Code (ECC) engine. The data may be data processed by Data Bus Inversion (DBI) or Data Masking (DM), and may include Cyclic Redundancy Code (CRC) information. The data may be encrypted data for security or privacy.

The storage devices 7150 to 7150m and 7250 to 7250m may transmit a control signal and a command/address signal to the NAND flash memory devices 7252 to 7252m in response to a read command received from the processor. Accordingly, when data is read from the NAND flash memory devices 7252 to 7252m, a read enable (RE) signal may be input as a data output control signal to output data to the DQ bus. A data strobe (DQS) may be generated using the RE signal. The command and address signals may be latched in the page buffer according to a rising edge or a falling edge of a write enable (WE) signal.

In an example embodiment, the storage devices 7150 to 7150m and 7250 to 7250m may adjust firmware parameters according to the storage device and the method of operating the same described with reference to FIGS. 1 to 12.

The controller 7251 may control the overall operation of the storage device 7250. In an example embodiment, the controller 7251 may include a static random access memory (SRAM). The controller 7251 may write data to the NAND flash 7252 in response to the write command, or may read data from the NAND flash 7252 in response to the read command. For example, the write command and/or the read command may be provided from the processor 7210 in the storage server 7200, the processor 7210m in the other storage server 7200m, or the processors 7110, 7110n in the application servers 7100 and 7100n. The DRAM 7253 may temporarily store (buffer) data to be written to the NAND flash 7252 or data read from the NAND flash 7252. Also, the DRAM 7253 may store metadata. In this case, the metadata is user data or data generated by the controller 7251 to manage the NAND flash 7252.

The storage device according to an example embodiment may be implemented to derive an optimal parameter by operating in a learning mode. The storage device according to an example embodiment may infer a relational expression between the parameter and an evaluation metric by using a plurality of models, and may derive an optimal parameter from the relational expression. For example, the parameter optimizer of the storage device may infer a relational expression between a parameter and an evaluation metric, using the machine learning model, and may derive an optimal parameter from the inferred relational expression.

In an example embodiment, when an evaluation metric of the storage device is provided as a plurality of evaluation metrics, the parameter optimizer may respectively infer a relational expression between a parameter and each evaluation metric by using a plurality of learning models, and may derive an optimal parameter or value of the parameter by comprehensively considering the inferred relational expressions.

As set forth above, in a storage device and a method of operating the same according to an example embodiment, performance may be increased by inferring relational expressions between parameters and performance metrics through machine learning and deriving an optimal parameter or value of the parameter using the inferred relational expressions.

While example embodiments have been described above, it will be apparent to those skilled in the art that various modifications and variations could be made without departing from the scope of the present inventive concept as defined by the appended claims.

What is claimed is:

1. A method of operating a storage device, comprising:
receiving a learning request for learning a new parameter value for a parameter;
evaluating a performance of a workload using a current parameter value of the parameter to generate performance metrics;
performing machine learning in response to the learning request using a plurality of learning models to infer relational expressions between the parameter and the performance metrics, using performance evaluation information according to a performance evaluation of the workload;
deriving the new parameter value using the inferred relational expressions; and
applying the new parameter value to a firmware algorithm.

2. The method of claim 1, wherein the parameter is one of a write throttling latency and a garbage collection to write ratio.

3. The method of claim 1, further comprising entering a learning mode in response to the learning request.

4. The method of claim 1, wherein the plurality of learning models include at least two of a throughput-related model, a write Quality of service (QoS)-related model, a read QoS-related model, and a reliability-related model.

5. The method of claim 1, wherein the workload is a combination of host-queue-depth and read-write-mixed Ratio.

6. The method of claim 1, further comprising storing the performance evaluation information according to a performance evaluation of the workload.

7. The method of claim 6, wherein the storing of the performance evaluation information includes storing the firmware algorithm, a parameter set, and the performance metrics in a form of a table.

8. The method of claim 6, wherein the performing of the machine learning includes inferring the relational expressions using the plurality of learning models and the performance evaluation information.

9. The method of claim 1, wherein the deriving of the new parameter includes deriving the new parameter value from the inferred relational expressions using a Bayesian optimization scheme.

10. The method of claim 1, wherein the deriving of the new parameter value is repeated a predetermined number of times.

11. A storage device comprising:
at least one non-volatile memory device; and
a controller connected to control pins providing a command latch enable (CLE) signal, an address latch enable (ALE) signal, a chip enable (CE) signal, a write enable (WE) signal, a read enable (RE) signal, and a data strobe (DQS) signal to the at least one nonvolatile memory device, and configured to control the at least one non-volatile memory device,
wherein the controller includes a buffer memory configured to store a plurality of learning models, and a processor configured to drive a parameter optimizer in response to a learning request from an external device for learning a new parameter value for a parameter, and
the parameter optimizer infers respective relational expressions between the parameter and respective performance metrics using the plurality of learning models, derives the new parameter value using the inferred relational expressions, and incorporates the new parameter value of the parameter into a storage algorithm.

12. The storage device of claim 11, wherein the parameter optimizer includes,
an evaluation history storage unit configured to store the performance metrics of a workload;
a performance relational inference unit configured to receive the performance metrics from the evaluation history storage unit, and to infer the relational expressions by performing machine learning on the performance metrics and each of the plurality of learning models; and
an optimal parameter derivation unit configured to derive the new parameter value by using the relational expressions.

13. The storage device of claim 12, wherein the parameter optimizer further comprises a learning interface unit configured to receive the learning request from the external device and enter a learning mode in response to the learning request.

14. The storage device of claim 12, wherein the parameter optimizer further comprises a workload evaluation unit configured to evaluate the performance metrics according to the workload by using a current parameter value of the parameter.

15. The storage device of claim 11, wherein the parameter optimizer repeats a process of deriving and incorporating the new parameter value a predetermined number of times, and updates a last derived parameter value as an optimal parameter value of the parameter in the storage algorithm.

16. A method of operating a storage device, comprising:
receiving a learning request for learning a new parameter value for a parameter;
evaluating a workload performance for a current value of the parameter to generate performance metrics;
storing the performance metrics;
inferring relational expressions between the parameter and the workload performance using the performance metrics;
deriving a new value of the parameter using the relational expressions;
incorporating the new value of the parameter into a firmware algorithm; and
when a number of iterations is not greater than a predetermined value, increasing the number of iterations by 1 and re-performing the evaluating of the workload performance.

17. The method of claim 16, wherein the inferring of the relational expressions includes performing machine learning using each of a plurality of learning models to infer the relational expressions.

18. The method of claim 16, wherein at least one of the performance metrics includes a predetermined percentile latency of a write latency.

19. The method of claim 16, further comprising selecting the performance metrics related to the parameter.

20. The method of claim 16, wherein the performance metrics include measures related to throughput, write QoS, read QoS, or reliability.
